(19) United States
(12) Patent Application Publication
(10) Pub. No.: US 2005/0199292 A1
(43) Pub. Date: Sep. 15, 2005

(54) Fluid device actuator with manual override

(76) Inventors: David W. Stedman, Mentor, OH (US); James L. Young, Madison, OH (US); Gary Scheffel, Streetsboro, OH (US); Jared Timko, Leroy Township, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/077,323

(22) Filed: Mar. 10, 2005

Related U.S. Application Data
(60) Provisional application No. 60/551,721, filed on Mar. 10, 2004.

(51) Int. Cl. F16K 37/00

(52) U.S. Cl. 137/553

(57) ABSTRACT

Apparatus for use with a fluid device includes an actuator having a first condition and having a second condition responsive to air under pressure for providing force for operating the fluid device. An override mechanism connected with the actuator is manually engageable to override the force provided by the actuator. The override mechanism may include a handle having a first handle position and a second handle position. The override mechanism may include a latching mechanism for automatically latching the handle in the selected handle position. The latching mechanism may be lockable.

### RELATED APPLICATION

This application claims the benefit of U.S. Application No. 60/551,721, filed Mar. 10, 2004, the entire disclosure of which is incorporated by reference.

### BACKGROUND OF THE INVENTION

1. Technical Field

This invention relates to actuators, for example, actuators for fluid flow control devices, such as valves. In particular, this invention relates to actuators and fluid devices that include a manual override feature for manually overriding the actuator (for example to close a valve), and that have a latch mechanism that automatically maintains the override position.

2. Description of the Prior Art

Some fluid flow control devices, such as valves, include a movable member that moves between an open position and a close position. When the movable member is in the open position, fluid can flow through the device. When the movable member is in the closed position, fluid flow through the device is blocked. Such devices use actuators to control, or actuate, movement of the movable member between the open and closed positions. The actuator can be a manual actuator, or it can be a remotely controlled actuator, such as an air operated actuator.

### SUMMARY OF THE INVENTION

In one aspect the invention relates to apparatus for use with a fluid device, including an air operated actuator having a first condition and having a second condition responsive to air under pressure for providing force to operate the fluid device. The apparatus also includes an override mechanism connected with the actuator that is manually engageable to override the force provided by the actuator.

In another aspect, the invention relates to apparatus including a valve including a valve member that is movable between a valve closed position and a valve open position. An air operated actuator is operable selectively to use air under pressure to provide force to effect movement of the valve member between the valve closed position and the valve open position. An override mechanism is manually operable to override the force provided by the actuator.

In still another aspect, the invention relates to apparatus including a valve including a valve member that can be moved between a valve closed position and a valve open position. An air operated actuator is operable selectively to use air under pressure to provide force to effect movement of the valve member between the valve closed position and the valve open position. An override mechanism is manually operable to override the force provided by the actuator, the override mechanism including a handle having a handle open position and a handle closed position. The override mechanism includes a latching mechanism for latching the valve member in the valve closed position in response to movement of the handle into the handle closed position.

In yet another aspect, the invention relates to apparatus for operating a fluid device. The apparatus includes a manually engageable handle for connection with a fluid device, the handle being rotatable about an axis between a first position and a second position to move the fluid device from a first condition to a second condition. The apparatus includes a latching mechanism that is responsive to rotation of the handle into the second position for latching the handle in the second position, the latching mechanism having a locking portion for selectively receiving a locking member to lock the handle in the second position thereby to lock the fluid device in the second condition. The latching mechanism is manually disengageable to enable rotational movement of the handle out of the second position.

### BRIEF DESCRIPTION OF THE DRAWINGS

Further features of the invention will become apparent to one of ordinary skill in the art to which the invention pertains from a reading of the following description in connection with the attached drawings, in which:

FIG. 1 is a perspective view of an override mechanism that is a first embodiment of the invention, shown in a first condition;

FIG. 2 is a view similar to FIG. 1 showing the override mechanism in a second condition;

FIG. 3 is an exploded perspective view of the mechanism of FIG. 1;

FIG. 4 is a sectional view of the mechanism of FIG. 1 shown in a first condition;

FIG. 5 is a sectional view similar to FIG. 4 showing the mechanism in a second condition;

FIG. 6 is an enlarged sectional view of a portion of the mechanism of FIG. 1, shown in an unlatched condition;

FIG. 7 is a view similar to FIG. 6 showing the mechanism in a latched condition;

FIG. 8 is a bottom plan view of a portion of the override mechanism of FIG. 1;

FIG. 9 is a perspective view of a portion of the override mechanism of FIG. 1;

FIG. 10 is a perspective view of an override mechanism that is a second embodiment of the invention, associated with an actuator and a valve;

FIG. 11 is a partial cutaway perspective view of the override mechanism of FIG. 10;

FIG. 12 is a sectional view of the override mechanism of FIG. 10, shown in an unlatched condition;

FIG. 13 is a view similar to FIG. 12 showing the mechanism in a latched condition;

FIG. 14 is an exploded perspective view of the mechanism of FIG. 10;

FIG. 15 is a top plan view of the mechanism of FIG. 10 shown at one end of its range of motion;

FIG. 16 is another top plan view of the mechanism of FIG. 10 shown in a condition between the ends of its range of motion; and

FIG. 17 is a partial cutaway sectional view of the mechanism of FIG. 10.

### DETAILED DESCRIPTION OF THE INVENTION

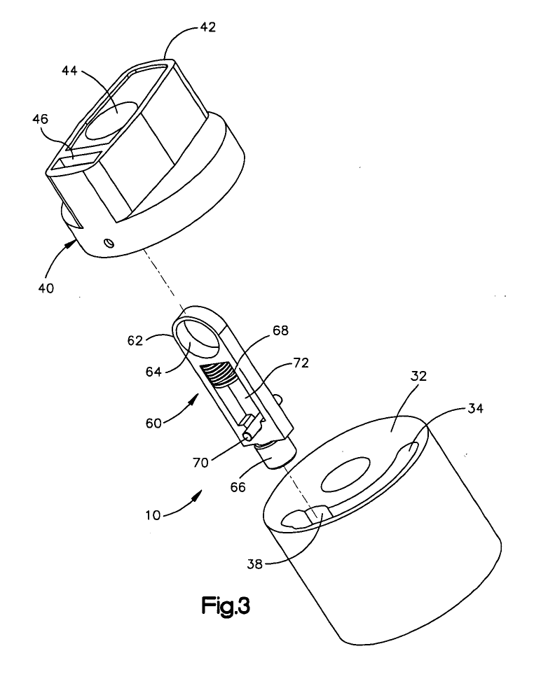

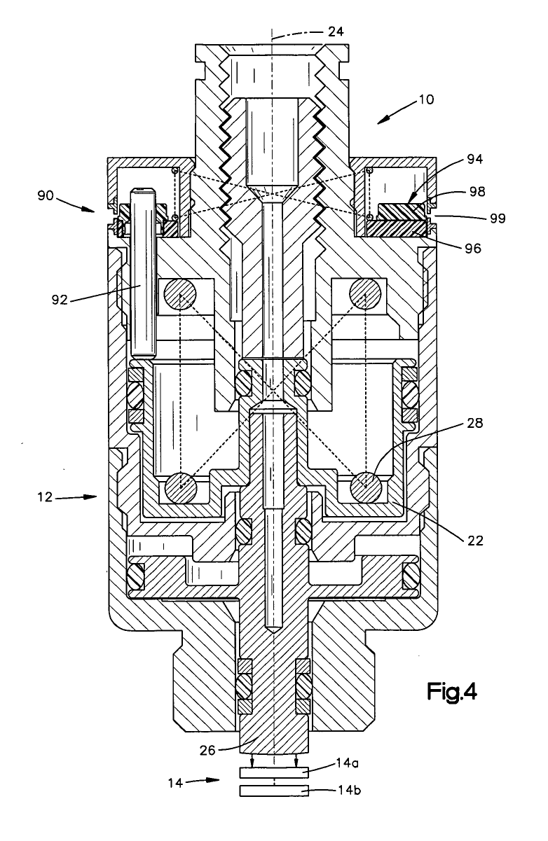

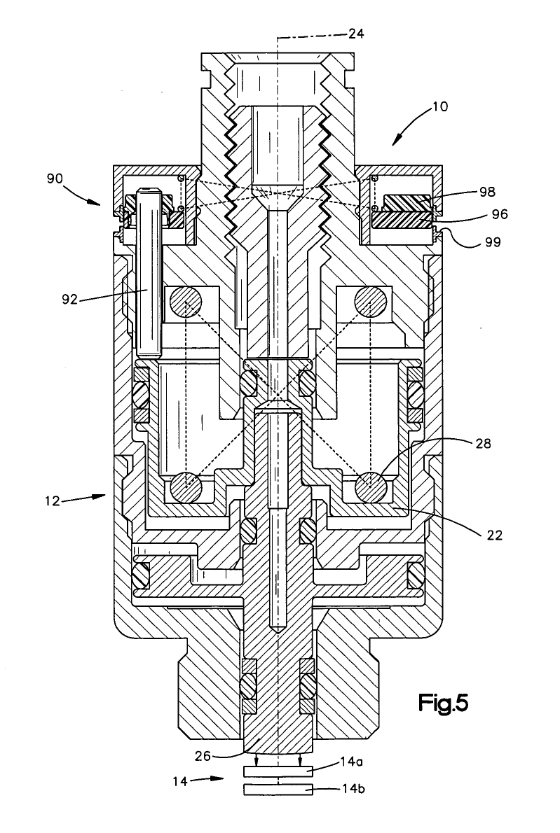

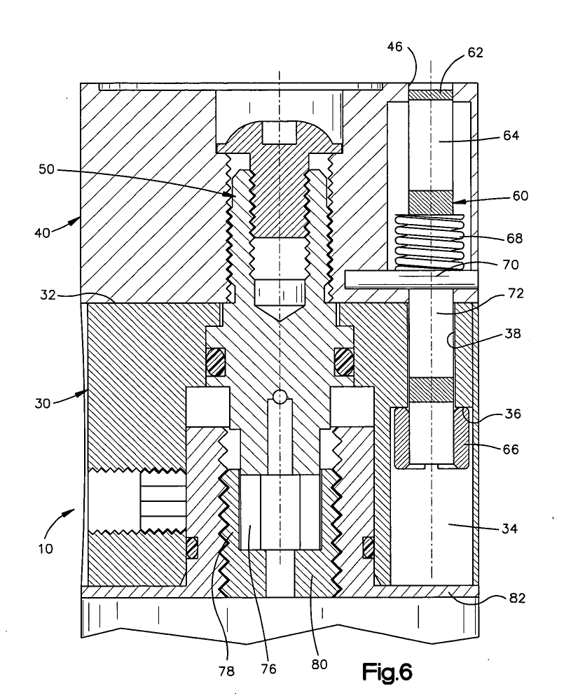

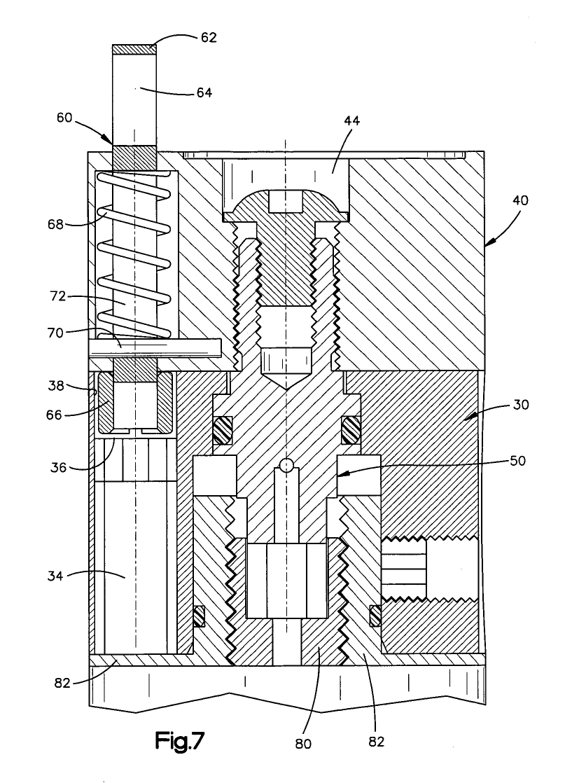

This invention relates to fluid flow control devices, such as valves. In particular, this invention provides actuators and fluid devices that include a manual override feature for manually overriding the actuator (for example to close a valve), and that have a latch mechanism that automatically maintains the override position. The invention is applicable to actuators and override mechanisms of varying constructions. The invention is illustrated with respect to a valve, but is usable also with other fluid devices, including but not limited to flow controllers, regulators, etc. As representative of one embodiment of the invention, FIGS. 1-9 illustrate an override mechanism 10 associated with an actuator 12. The actuator 12 is for controlling a valve 14, portions of which are shown schematically in FIGS. 4 and 5.

The valve 14 includes a valve seat 14b and a valve member 14a that is movable relative to the valve seat between an open position spaced apart from the valve seat and a closed position in engagement with the valve seat. When the valve member 14a is in the open position, fluid flow through the valve 14 is enabled; when the valve member is in the closed position, fluid flow through the valve is blocked. In the particular valve 14 illustrated, the valve member is preferably a flexible diaphragm that tends to want to assume a position in which the valve is open. This tendency is counteracted as described below.

The actuator 12 is operable to move the valve member 14a from the open position to the closed position. The invention is applicable to actuators of varying types, including air actuators and the particular actuator one shown. The actuator 12 shown is an air-operated actuator that accepts air under pressure through an air inlet to move a piston member 22 upward along an axis 24 as viewed in FIG. 4. The actuator 12 is remotely operable. That is, the force for operating the actuator 12 comes from a location remote from the actuator and from the valve.

Movement of the piston member 22 is transmitted to a stem 26 that moves along the axis 24. The stem 26 is engageable directly or indirectly with the diaphragm (valve member 14a) so that when the stem is moved upward, the diaphragm is free to move to its normally open position.

When air pressure on the piston 22 is released, it and the stem 26 move downward under the influence of a spring 28. The downward movement of the stem 26 causes the diaphragm 14a to be moved to its closed position. Thus, the valve 14 is a normally closed valve. The invention is applicable to normally open valves also.

The apparatus shown in FIGS. 1-9 also includes a manual override mechanism 10 for the actuator 12. As described below, the override mechanism 10 is operable, upon receipt of manual force at the location of the actuator 12, to set the valve in the closed position, regardless of whether the actuator has the valve set in the open position. Thus, if the actuator 12 is supplying air pressure to the piston 22 to set the valve in the open position, the override mechanism 10 is operable to move the valve to the closed position by moving the stem 26, against (overriding) the continuing air pressure, as described below. The override mechanism 10 preferably automatically latches in this position, and can additionally be locked in this position thus locking the valve in the closed position. On the other hand, if the actuator 12 already has the valve set in the closed position, the override mechanism 10 is operable to lock the valve in the closed position.

The major components of the particular override mechanism 10 that is illustrated (other embodiments are possible) include a collar 30; a handle 40; a stem 50; a visual indicator in the form of a button 60; an actuator screw 80; and a cap 82.

The collar 30 is a generally cylindrical body fixed to the valve body and having an upper surface 32 adjacent to the handle 40. The collar 30 has an internal cavity in form of a track 34. The track 34 is an open space or opening in the collar 30 that receives for movement therein a portion 66 of the button 60 as described below. The track 34 has an arcuate configuration centered on the axis 24 and extending for about ninety degrees about the axis. An internal surface in the collar forms a lip 36 that defines the top of the track 34. At one end of its arc, the lip 36 is narrowed or removed to form a circular passage 38 in the collar 30, extending upward from the track through the upper surface 32 of the collar.

The handle 40 is supported on the stem 50 for rotation about the axis 24 relative to the collar 30 between a valve open position and a valve closed position. The handle 40 has a manually engageable portion 42 for receiving manual force. Upon such receipt of manual force, the handle 40 is rotatable about the axis 24, relative to the collar 30, within a ninety-degree range as described below.

The handle 40 has a central opening 44 for receiving the stem 50. The handle 40 also has a vertically extending through hole 46 at one location spaced outward from the axis 24. The through hole 46 is aligned with the track 34 in the underlying collar 30. Thus, as the handle 40 rotates above the collar 30, the through hole 46 in the handle moves along and over the track 34 in the collar.

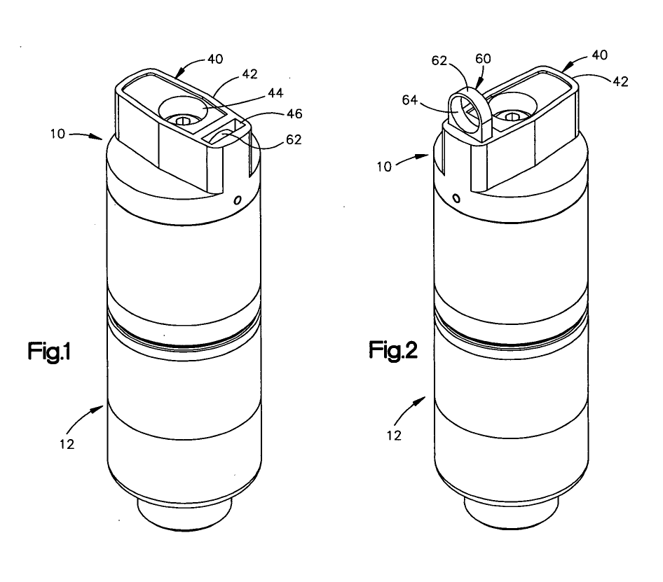

The button 60 is supported in the collar 30 and handle 40 for rotation with the handle and for axial movement relative to the handle and the collar. The button 60 has an extended position as shown in FIG. 2 and a retracted position as shown in FIG. 1.

The button 60 has an upper end portion 62 that is received in the through hole 46 in the handle 40. The upper end portion 62 of the button 60 has an opening 64 adapted to receive a locking member (not shown) such as a hasp of a padlock, or a locking bar or cable.

The button 60 has an inner end portion or lower end portion 66 that is wider than the lip 36 at all locations other than the upper opening or passage 38. This size difference prevents the lower end portion 66 of the button 60 from moving axially out of the track 34 unless the button is aligned with the passage 38. Thus, the button 60 is located either wholly in the collar 30, or partially in both the handle 40 and the collar 30.

The override mechanism 10 includes a mechanism or means for biasing the button 60 into the extended position. In the illustrated embodiment, the mechanism or means is a compression spring 68. The spring 68 acts between the button 60 and a pin 70 which is fixed in the handle 40, to bias the button toward the extended position. The pin 70 extends through a central slot 72 in the button 60.

The handle 40 is secured by a set screw to the stem 50. The stem 50 has a splined lower end portion 76 that is connected with a splined upper end portion 78 of the actuator screw 80. The actuator screw 80 is screw threaded in a fixed cap 82. As a result, rotation of the handle 40 and the stem 50 cause rotational movement of the actuator screw 80 in the cap 82 as well as axial movement of the actuator screw in the cap. The lower end 84 of the actuator screw 80 is engageable with the piston 22.

In operation of the override mechanism 10, the handle 40 is manually engageable to receive force to turn the handle relative to the collar 30. When the handle 40 is turned, the stem 50 and the actuator screw 80 turn also. The actuator screw 80, because it is threaded in the cap 82, moves axially as it rotates in the cap. The axial motion of the actuator screw 80 is transmitted through the piston 22 to the valve stem and thereby to the valve diaphragm. The diaphragm is moved from the open position to its closed position. Once the handle 40 has been turned about ninety degrees on the collar 30, the valve diaphragm is moved into the closed position. This closing movement of the valve overrides any air pressure induced opening of the valve, and thus occurs even if the actuator 12 has set the valve in the open position.

The rotation of the handle 40 also causes the button 60 to orbit about the axis 24, because the upper end portion 62 of the button is located in the through hole 46 in the handle. As the button 60 orbits about the axis 24, the lower end portion 66 of the button moves along the track 34. When the handle reaches the handle closed position at the end of its range of motion, the lower end portion 66 of the button 60 has moved far enough along the track 34, to a point at which the lip 36 on the collar 30 no longer blocks upward movement of the button. The biasing force of the spring 68, acting to push the button 60 upward toward its extended position, causes the second end portion 66 of the button to move axially upward out of the track 34 into the passage 36.

The upper end portion 62 of the button 60 also moves axially upward, extending or projecting out of the through hole 46 of the handle 40. This upward “popping” movement of the button 60 provides a visual indication to the operator that the valve is in the closed position. In this manner, the button 60 serves as an indicator member to the operator.

The button 60 moves up until the end of the slot 72 engages the pin 70. In this position, the lower end portion 66 of the button 60 is disposed in the widened passage 38 in the collar 30. When the parts of the override mechanism 10 are in this position, the handle 40 can not easily be turned back to its valve open position. Specifically, because the lower end portion 66 of the button 60 is in the passage 38 in the collar 30, and not in the track 34, the button can not move back along the track. The button 60 is therefore fixed in rotational position relative to the collar 30. At the same time, the upper end portion 62 of the button 60 is located in the through hole 46 in the handle 40. The positioning of the button 60 in the through hole 46 of the handle 40 blocks rotation of the handle relative to the collar 30, about the axis 24. As a result, the handle 40 can not be rotated back to the handle open position, and the button 60, because it extends across the joint between the handle and the collar 30, serves as a latching member that blocks movement of the handle out of the handle closed position, thus blocking movement of the valve to the valve open position.

This blocking action can deter inadvertent valve opening. This blocking action occurs automatically whenever the handle 40 is turned to the valve open position. It can be disabled only by manually pushing the button 60 back down far enough so that the lower end portion 66 of the button is in the track 34, against the bias of the spring 68, and simultaneously turning the handle 40 away from the valve closed position.

When the upper end portion 62 of the button 60 thus projects from the handle 40, the opening 64 in the button is exposed. The hasp of a padlock, or another locking mechanism such as a lock bar or cable, can be placed through the opening 64. This blocks axial movement of the button 60 back down into the handle 40. The valve is thus “locked out” until the locking member is removed from the button 60.

When any such locking member is removed from the button 60 and it is desired to release the latching mechanism, the projecting upper end portion 62 of the button is manually engaged and pushed downward into the handle 40. This causes the lower end portion 66 of the button 60 to move out of the passage 38 in the collar 30, to a position below the lip 36 and in the track 34. The lower end portion 66 of the button 60 is then movable circumferentially in the track 34. Rotational force applied to the handle 40 is transmitted through the upper end portion 62 of the button 60 to the lower end portion 66 of the button, causing it to move circumferentially in the track 34 back toward the starting position. This freeing up of the button 60 to move in the collar 30 enables the handle 40 to be rotated on the collar, causing the valve to be opened.

The device shown in FIGS. 1-9 also includes another visual indicator of valve position. This indicator 90 is usable with any fluid device that relies on axial movement to control fluid flow, and is especially useful with the particular override mechanism that is illustrated, because its handle position itself does not necessarily show whether the underlying valve is open or closed.

The indicator 90 includes three stems 92 located at 120° intervals about the axis 24. Each stem 92 moves up and down with the piston 22. Each stem 92 is adjustably attached at its upper end to an annular indicator ring 94 that has a green ring portion 96 and a red ring portion 98.

When the valve 14 is first set up, the position of the indicator 90 (the ring 94 relative to the stems 92) is set so that it shows correctly. When the piston 22 moves up, allowing the valve 14 to open, the stems 92 move the indicator ring 94 up, and the green ring portion 96 shows through a slot 99. When the piston 22 moves down, closing the valve 14, the stems 92 move the indicator ring 94 down, and the red ring portion 98 shows through the slot 99.

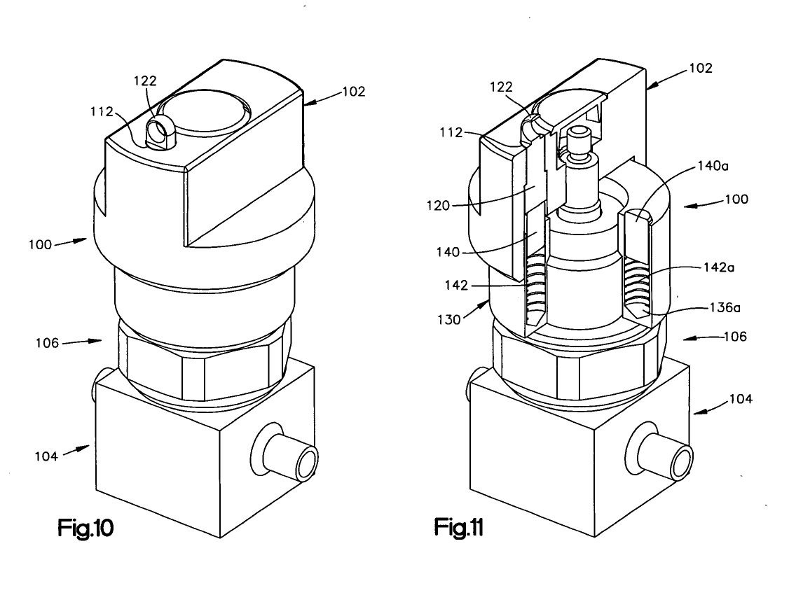

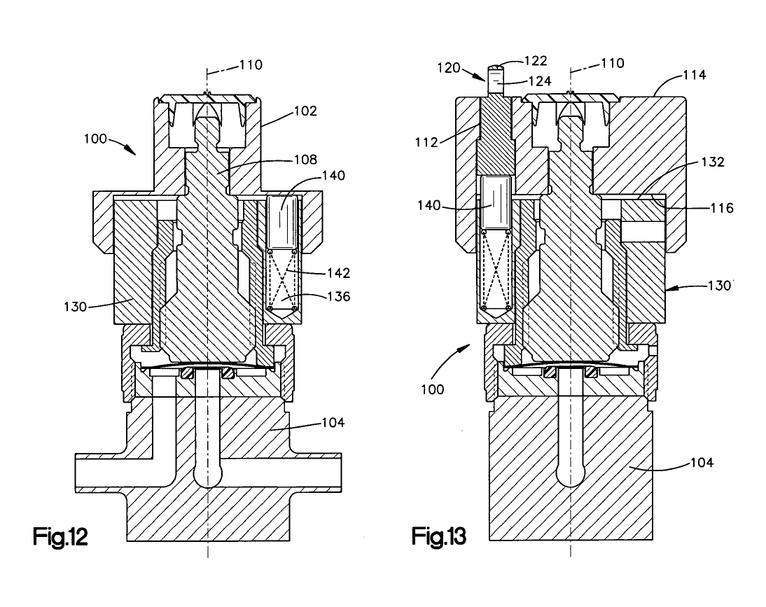

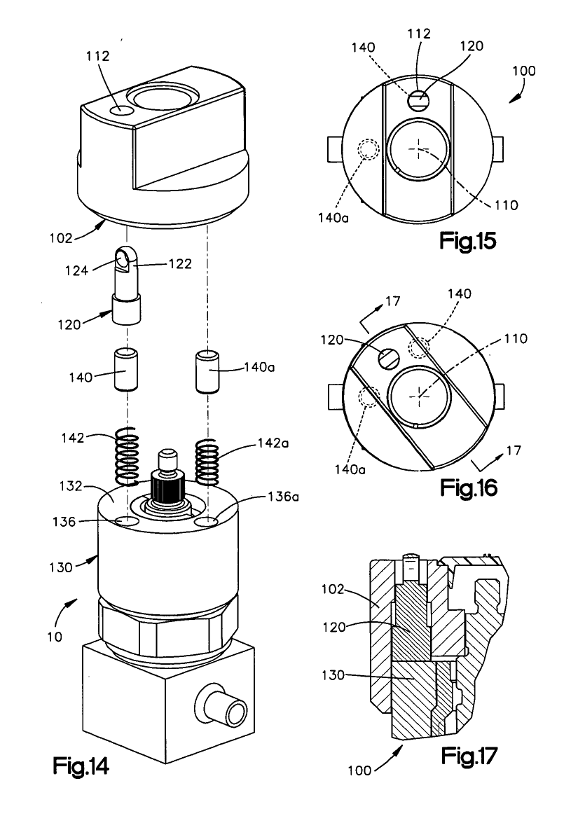

FIGS. 10-16 illustrate a mechanism 100 that is a second embodiment of the invention. The mechanism 100 includes a handle 102 for a valve 104 that has a valve actuator 106. The valve 104 and valve actuator 106 may be the same as or similar to those shown in FIGS. 1-9. The mechanism 100 as illustrated is thus a latching override mechanism for an actuator. The mechanism 100 is also usable as simply a rotatable handle for a valve, such as a quarter turn valve, that does not have an actuator associated with it.

The handle 102 is splined to or otherwise connected for rotation with an actuator stem 108. Rotation of the handle 102 about an axis 110 results in rotation of the actuator stem 108 and consequent opening and closing of the valve 104. The handle 102 has a single through hole 112 at a location spaced radially outward from the axis 110. The through hole 112 extends axially between a top surface 114 and a bottom surface 116 of the handle 102.

An indicator member 120 is located in the through hole 112 in the handle 102. The indicator member 120 is supported in the through hole 112 for vertical sliding movement in a direction parallel to the axis 110. The indicator member 120 has an upper end portion 122 that includes a lock member opening 124. The indicator member 120 is rotatable with the handle 102 about the axis 110.

The override mechanism 100 includes a collar 130 that is mounted on the fixed portion of the valve 104 and/or valve actuator 106. The collar 130 has a generally cylindrical configuration including an annular top surface 132 that is adjacent to a bottom surface 134 of the handle 102.

The collar 130 is fixed in position rotationally on the valve 104 and/or the valve actuator 106. The collar 130 has two plunger openings 136 and 136a spaced apart circumferentially by ninety degrees. The plunger openings 136 and 136a extend downward from the top surface 132 of the collar 130. The plunger openings 136 and 136a are spaced apart from the axis 110 by the same distance as the through hole 112 in the handle 102.

A plunger 140 and a spring 142 are received in the plunger opening 136. The spring 142 biases the plunger 140 upward, that is, in a direction toward the top surface 132 of the collar 130 and the handle 102. The spring 142 is compressible enough so that the plunger 140 can be received completely in the plunger opening 136 in the collar 130 without projecting out of the top surface 132 of the collar. In a similar manner, a second plunger 140a is received in the second plunger opening 136a, together with a second spring 142a.

When the handle 102 is rotated about the axis 110, it rotates relative to the collar 130 and thus relative to the plungers 140. As a result, the through hole 112 and the indicator member 120 revolve about the axis 110, along the same arc on which are located the plungers 140. The handle 102 rotates about the axis 110 through a ninety degree range of motion as the valve 104 moves between its open condition and its closed condition.

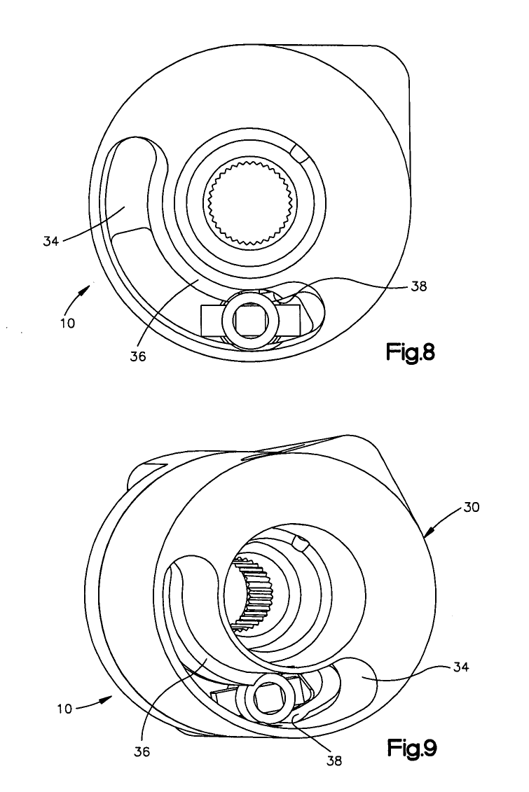

When the handle 102 is at one end of its ninety degree range of motion about the axis 110, for example as shown in FIG. 11, the valve 104 is in the closed position. The through hole 112 is located over the first plunger 140. When the parts are thus aligned, the force of the spring 142 acts on the first plunger 140 to push the first plunger and also the indicator member 120 upward, to a position as shown in FIG. 11. The plunger 140 extends across the joint between the top surface 132 of the collar 130 and the lower surface 116 of the handle 102. As a result, the plunger 140 blocks rotation of the handle 102 relative to the collar 130, and the valve 104 is thus latched in the closed position.

At the same time, the indicator member 120 is pushed upward in the handle 102 so that its upper end portion 122 projects from the top surface 114 of the handle. This provides a visual indication of the closed and latched condition of the valve 104.

The projecting end portion 122 of the indicator member 120 can receive, through the opening 124, a locking member (not shown) in the form of a padlock or a lock bar or cable. This enables the valve 104 to be externally locked, not merely internally latched, in the open position. The indicator member 120 is rotatable in the opening in the handle 102. Therefore, the opening 124 can be aligned in any orientation, regardless of the handle open or handle closed position of the override mechanism 100. This can facilitate use of a cable or a locking bar for locking multiple fluid devices in a row. Other variations of this and other embodiments are possible, that do not include a lock member opening like the opening 124; such variations would be bump proof but not lockable.

In a similar manner, when the handle 102 is at the other end (not shown) of its ninety degree range of motion about the axis 110, the valve 104 is in the open position. The through hole 112 in the handle 102 is located over the second plunger 140a. The force of the second spring 142a acts on the second plunger 140a to push the second plunger and the indicator member 120 upward. The second plunger 140a extends across the joint between the upper surface 132 of the collar 130 and the lower surface 116 of the handle 102. As a result, the second plunger 140a blocks rotation of the handle 102 relative to the collar 130, and the valve 104 is thus latched in the closed position.

Other embodiments of a locking mechanism like the mechanism 100 might include only one plunger. In such a case, the mechanism would latch (and provide a visual indication thereof) at only one end of its ninety degree range of motion. In addition, the invention in all its forms is applicable to fluid devices that are rotatable over a range of motion other than 90 degrees, for example, 180 degrees or 270 degrees or another angle.

1. Apparatus for use with a fluid device, the apparatus comprising:
an air operated actuator having a first condition and having a second condition responsive to air under pressure for providing force to operate the fluid device; and
an override mechanism connected with the actuator that is manually engageable to override the force provided by the actuator.

2. Apparatus as set forth in claim 1 wherein the override mechanism includes a handle that is rotatable about an axis from a first handle position to a second handle position to override the force provided by the actuator.

3. Apparatus as set forth in claim 2 wherein the override mechanism includes a visual indicator responsive to operation of the override mechanism for indicating a condition of the fluid device.

4. Apparatus as set forth in claim 3 wherein the visual indicator is rotatable thereby to enable engagement of the visual indicator by a locking member regardless of the rotational position of the handle.

5. Apparatus as set forth in claim 1 wherein the override mechanism includes a latching mechanism for automatically latching the override mechanism in a position overriding the force of air under pressure supplied by the actuator.

6. Apparatus comprising:
a valve including a valve member that is movable between a valve closed position and a valve open position;
an air operated actuator that is operable selectively to use air under pressure to provide force to effect movement of the valve member between the valve closed position and the valve open position; and
an override mechanism that is manually operable to override the force provided by the actuator.

7. Apparatus as set forth in claim 6 wherein the override mechanism includes a handle that is rotatable about an axis between a handle open position and a handle closed position, the handle being manually engageable to receive and transmit force to the valve member to cause the valve member to move between the valve open position and the valve closed position.

8. Apparatus as set forth in claim 6 wherein the override mechanism includes a latching mechanism for automatically latching the valve member handle in the selected valve position.

9. Apparatus as set forth in claim 8 wherein the override mechanism includes a manually rotatable handle and the latching mechanism moves from a non-latching condition to a latching condition in response to rotation of the handle, the latching mechanism when in the latching condition blocking rotational movement of the handle out of the selected handle position, the latching mechanism being manually movable from the latching condition to a non-latching condition to enable rotational movement of the handle out of the selected handle position.

10. Apparatus as set forth in claim 6 wherein the valve is a normally closed valve, and the actuator is operable selectively to provide force to move the valve out of its closed condition, and the override mechanism is operable selectively to override the force provided by the actuator and hold the valve in is closed condition.

11. Apparatus as set forth in claim 6 including a visual indicator that is operable in response to operation of the override mechanism to indicate the valve open or valve closed condition of the valve member.

12. Apparatus as set forth in claim 11 wherein the visual indicator is a member that extends from the top of a manually rotatable handle and that is adapted to accept a locking member.

13. Apparatus comprising:
a valve including a valve member that can be moved between a valve closed position and a valve open position;
an air operated actuator that is operable selectively to use air under pressure to provide force to effect movement of the valve member between the valve closed position and the valve open position; and
an override mechanism that is manually operable to override the force provided by the actuator, the override mechanism including a handle having a handle open position and a handle closed position;
the override mechanism including a latching mechanism for latching the valve member in the valve closed position in response to movement of the handle into the handle closed position.

14. Apparatus as set forth in claim 13 wherein the latching mechanism is manually disengageable from the latching condition to enable movement of the handle out of the handle closed position.

15. Apparatus as set forth in claim 14 wherein the latching mechanism includes a latching member that projects from a top surface of the handle when the latching mechanism is in the latching condition.

16. Apparatus as set forth in claim 15 wherein the latching member is rotatable relative to the handle.

17. Apparatus comprising:
a valve including a valve member that can be moved between a valve closed position and a valve open position;
an air operated actuator that is operable selectively to use air under pressure to provide force to effect movement of the valve member between the valve closed position and the valve open position; and
an override mechanism that is manually operable to override the force provided by the actuator;
the override mechanism including a handle that is rotatable about an axis between a handle open position and a handle closed position, the handle being manually engageable to receive and transmit force to cause the valve member from the valve open position to the valve closed position to override the force being provided by the actuator;
the override mechanism also including a visual indicator that is operable in response to operation of the override mechanism to indicate the valve open or valve closed condition of the valve member;
the override mechanism also including a latching mechanism for automatically latching the valve member in the valve closed position in response to operation of the override mechanism.

18. Apparatus as set forth in claim 17 wherein the visual indicator is a member that extends from the top the handle and that is adapted to be engaged by a locking member to block handle rotation and thereby to block movement of the valve out of the valve closed position.

19. Apparatus as set forth in claim 18 wherein the visual indicator is rotatable relative to the handle thereby to enable engagement of the visual indicator by a locking member regardless of the rotational position of the handle.

20. Apparatus for operating a fluid device, comprising:
a manually engageable handle for connection with a fluid device, the handle being rotatable about an axis between a first position and a second position to move the fluid device from a first condition to a second condition, and
a latching mechanism that is responsive to rotation of the handle into the second position for latching the handle in the second position, the latching mechanism having a locking portion for selectively receiving a locking member to lock the handle in the second position thereby to lock the fluid device in the second condition;
the latching mechanism being manually disengageable to enable rotational movement of the handle out of the second position.
